(19) United States
(12) Patent Application Publication
(10) Pub. No.: US 2015/0146837 A1
(43) Pub. Date: May 28, 2015

(54) OSCILLATION POWER RANGE MONITOR SYSTEM AND A METHOD OF OPERATING A NUCLEAR POWER PLANT

(71) Applicant: Kabushiki Kaisha Toshiba, Minato-ku (JP)

(72) Inventors: Tadashi MIYAZAKI, Yokohama (JP); Toshiaki ITO, Koto (JP)

(21) Appl. No.: 14/541,802

(22) Filed: Nov. 14, 2014

(30) Foreign Application Priority Data
Nov. 25, 2013 (JP) 2013-242755

(51) Int. Cl. G21C 17/00; G01T 3/00

(52) U.S. Cl. CPC G21C 17/00; G01T 3/00
USPC 376/254

(57) ABSTRACT

According to an embodiment, an oscillation power range monitor system has a plural of OPRM units. Each of the OPRM units has: the receiving cell-output set signals and averaging the cell-output set signals; a time average calculating unit calculating a time average cell value; a normalized cell value calculating unit calculating a normalized cell value; a trip determining unit outputting a reactor trip signal if amplitude or growth rate of oscillation or period of oscillation of the normalized cell value has exceeded a prescribed condition; a signal and prescribed value adjusting unit adjusting the relation between the normalized cell value and the specific value, thereby compensating for the deterioration in the neutron flux sensitivity of any LPRM detector in order to keep outputting the reactor trip signal.

### CROSS-REFERENCE TO RELATED APPLICATION

This application is based upon and claims the benefit of priority from Japanese Patent Application No.2013-242755 filed on Nov. 25, 2013, the entire content of which is incorporated herein by reference.

### FIELD

Embodiments described herein relate generally to an oscillation power range monitor system and a method of operating a nuclear power plant.

### BACKGROUND

In a boiling-water reactor (hereinafter referred to as BWR), the local power in the core repeatedly changes: decreasing caused by generation of the void; and increasing caused by vanishing of the void. The power of the nuclear reactor may therefore oscillate, and the oscillation may increase gradually. The oscillation of the core power is monitored by an oscillation power range monitor system, which uses the detection signal from a local power range monitor (hereinafter referred to as LPRM). Such a system is disclosed in Japanese Patent No. 3,064,084, the entire content of which is incorporated herein by reference.

In the oscillation power range monitor system, output signals of the LPRM detectors arranged in the reactor core are allocated to monitoring cells, respectively. That is, a plurality of signals from the LPRM detectors are input to each monitoring cell of the oscillation power range monitor system. The LPRM detection signals input to the monitoring cells have been normalized. Thus, the local oscillation power range monitor system monitors the oscillation of the average value of the normalized LPRM detection signals. The local oscillation power range monitor system generates a reactor trip signal to shut down the reactor automatically, if the period, amplitude and growth rate of the power oscillation monitored exceed respective predetermined threshold values.

The nuclear fission proceeding in the reactor core generates neutrons and fission products. Some radioactive fission products emit gamma rays as they disintegrate. Thus the gamma rays are emitted by the fission process. But the gamma rays are generated with a time delay, unlike the neutrons are generated at the time when the fission takes place. Hence, if the core power oscillates, the gamma-ray level oscillates with some time delay relative to the oscillation of the neutron flux level.

The signal inputs from LPRM detectors to each monitor cell contain a neutron flux component and a gamma-ray flux component. The ratio of the gamma-ray flux component to the neutron flux component gradually increases as the detector's sensitivity to neutron flux deteriorates. The period, amplitude and growth rate of the neutron flux component oscillation must be monitored in order to determine the core power oscillation. However, the neutron flux component and the gamma-ray flux component cannot be isolated from each other. If the ratio of the gamma-ray flux component increases in the detection signal because of the deterioration in the detector's sensitivity to neutron flux, the ratio of the component time-delayed will increase, possibly delaying the detection of the core power oscillation.

### BRIEF DESCRIPTION OF THE DRAWINGS

FIG. 1 is a block diagram showing the configuration of an oscillation power range monitor system according to the first embodiment;

FIG. 2 is a plan view showing an exemplary arrangement of the LPRM strings in the reactor core, for describing the oscillation power range monitor system according to the first embodiment;

FIG. 3 is a bird's-eye view showing the relation between the cell-output sets processed in the oscillation power range monitor system according to the first embodiment and the LPRM detectors;

FIG. 4 is a diagram showing the relation between the change with time of the output signal and a preset value in the oscillation power range monitor system according to the first embodiment;

FIG. 5 is a flowchart showing a method of operating the nuclear power plant by using the oscillation power range monitor system according to the first embodiment;

FIG. 6 is a block diagram showing the configuration of an oscillation power range monitor according to the second embodiment;

FIG. 7 is a block diagram showing the configuration of an oscillation power range monitor according to the third embodiment; and

FIG. 8 is a diagram showing the relation between the change with time of the output signal and a preset value in the oscillation power range monitor system according to the third embodiment.

### DETAILED DESCRIPTION

In view of the above-identified problems, therefore, the object of an embodiment of the present invention is to provide an oscillation power range monitor system that decreases the delay of detecting the core power oscillation, in spite of the decreasing of the sensitivity to neutron fluxes.

According to an embodiment, there is provided an oscillation power range monitor system designed to monitor oscillation of power of a nuclear reactor and output a reactor trip signal to shut down the nuclear reactor automatically if the oscillation is found abnormal, the system comprising: a plurality of OPRM units, each of the OPRM units receiving and processing cell-output set signals coming from any selected LPRM detectors of LPRM strings arranged at the four corners of a cell of a lattice, the LPRM strings being arranged in a reactor core in the form of the lattice on the horizontal plane of the reactor core, each LPRM strings having a plurality of LPRM detectors configured to detect a neutron flux and a gamma-ray flux and having neutron flux sensitivity more decreasing than gamma-ray flux sensitivity over a period for measuring the neutron flux, wherein each of the OPRM units has: a cell average calculating unit receiving cell-output set signals and averaging the cell-output set signals, thereby calculating a cell average value; a time average calculating unit calculating a time average cell value that is temporal average of the value calculated by the cell average calculating unit in a prescribed time period; a normalized cell value calculating unit calculating a normalized cell value that is a ratio of the average cell value to the time average cell value; a trip determining unit outputting a reactor trip signal if amplitude or growth rate of oscillation of the normalized cell value has exceeded a prescribed value, or period of oscillation of the normalized cell value has exceeded a prescribed condition; and a signal and prescribed value adjusting unit adjusting relation between the normalized cell value and the specific value, thereby compensating for deterioration in the neutron flux sensitivity of any LPRM detector in order to keep outputting the reactor trip signal.

According to another embodiment, there is provided a method of operating a nuclear power plant comprising an oscillation power range monitor system designed to monitor oscillation of power of a nuclear reactor and output a reactor trip signal to stop the nuclear reactor automatically if the oscillation is found abnormal, the system comprising OPRM units, each of the OPRM units receiving and processing cell-output set signals coming from any selected LPRM detectors of LPRM strings arranged at the four corners of a cell of a lattice, the LPRM strings being arranged in a reactor core in the form of the lattice on the horizontal plane of the reactor core, each LPRM strings having a plurality of LPRM detectors configured to detect a neutron flux and a gamma-ray flux and having neutron flux sensitivity more decreasing than gamma-ray flux sensitivity over a period for measuring the neutron flux, the method comprising: an in-plant measuring step of performing thermal power calibration and core power distribution measuring while the nuclear power plant is operating; an LPRM gain adjusting step of adjusting the gain of the LPRM signal in accordance with the result of the in-plant measuring step; an OPRM correction value determining step of determining, from the result of the LPRM-gain adjusting step, a correction value for the signal and prescribed value adjusting unit of the oscillation power range monitor system; and an OPRM correction value changing step of changing the correction value to the value determined in the OPRM correction value determining step.

Oscillation power range monitor systems and methods of operating a nuclear power plant according to embodiments of the present invention will be described with reference to the accompanying drawings. In the drawings, the components identical or similar are designated by the same number. Such components will not be described repeatedly.

### First Embodiment

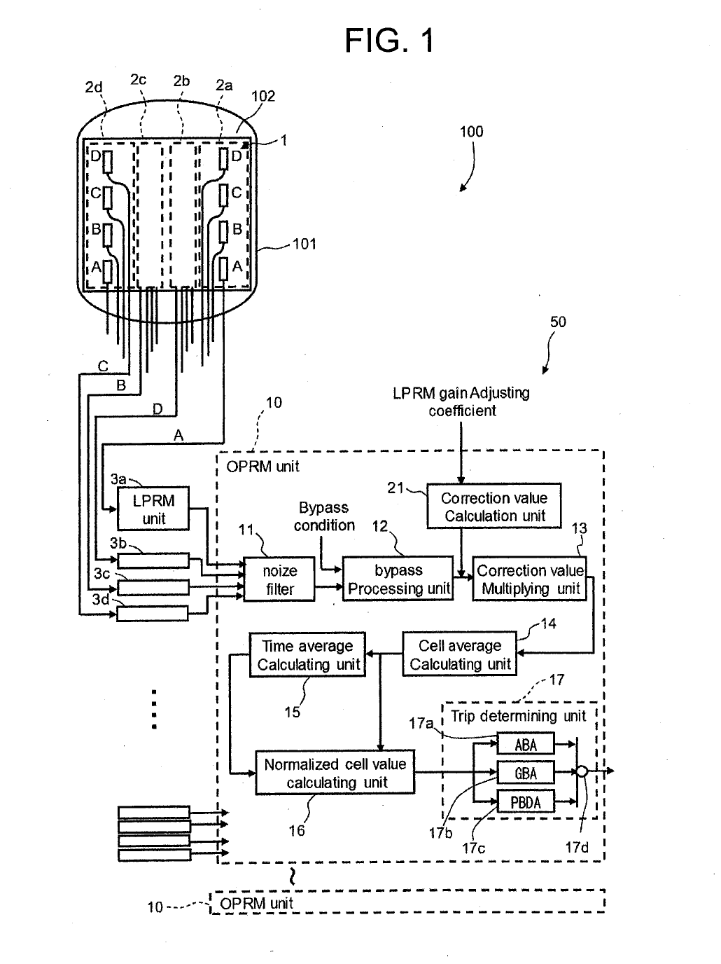

FIG. 1 is a block diagram showing the configuration of an oscillation power range monitor system according to the first embodiment. In a reactor core 102 housed in a reactor pressure vessel 101, LPRM strings 2a, 2b, 2c and 2d are configured to measure neutron fluxes at each position. Each of the LPRM strings 2a, 2b, 2c and 2d has four LPRM detectors 1 (detectors A, B, C and D), which are arranged upwards in a column at regular intervals in the order mentioned. The LPRM detectors 1 output neutron flux signals to LPRM units 3a, 3b, 3c and 3d, respectively. The LPRM units 3a, 3b, 3c and 3d convert the neutron flux signals, which are analog signals, to digital signals.

The oscillation power range monitor (OPRM) system 50 has a plurality of OPRM units 10 configured to receive the four neutron flux signals from each of the LPRM units 3a, 3b, 3c and 3d.

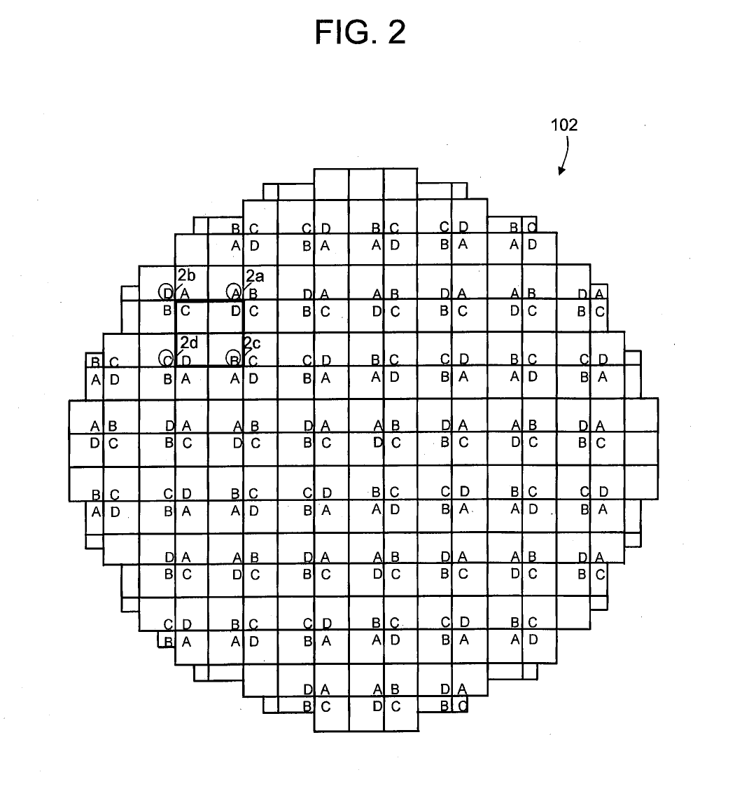

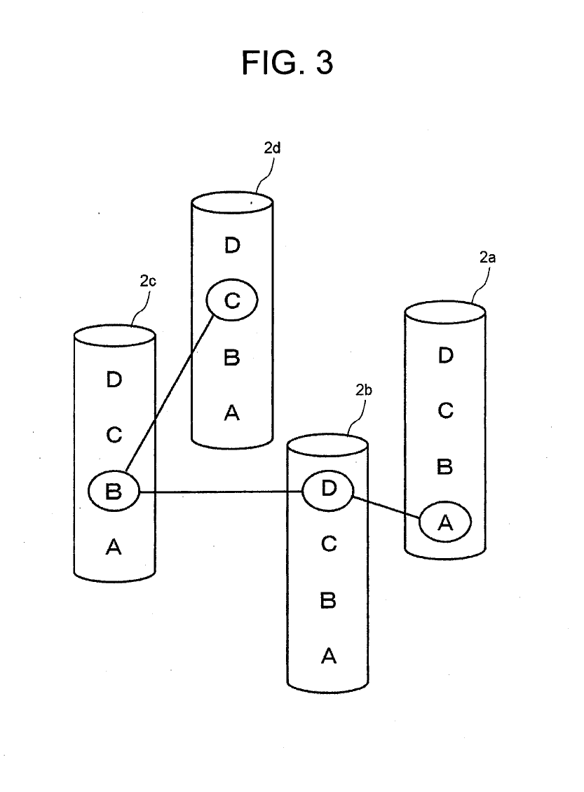

Before describing the OPRM units 10, the relation between: the oscillation power range monitor system 50; and the LPRM detectors 1, LPRM strings 2a, 2b, 2c and 2d, and LPRM units 3a, 3b, 3c and 3d with reference to FIG. 2 and FIG. 3.

FIG. 2 is a plan view showing an exemplary arrangement of the LPRM strings in the reactor core, for describing the oscillation power range monitor system according to the first embodiment. In the reactor core 102, LPRM strings 2a, 2b, 2c and 2d are provided at, for example, the four corners of a cell indicated by a thick-line square. As described above, the LPRM strings 2a, 2b, 2c and 2d have LPRM detectors A, B, C and D, respectively. For convenience of illustration, in FIG. 2 the LPRM detectors A, B, C and D are shown as arranged horizontally, each at a corner of one cell. In practice, however, the LPRM detectors A, B, C and D are arranged in the vertical direction in the same guiding conduit. The LPRM detectors A of the respective LPRM strings are arranged at the same height. The LPRM detectors B, LPRM detectors C and LPRM detectors D are arranged at the same height, too. In the reactor core 102, the LPRM strings of this configuration are arranged in the form of a lattice, and the cells surrounded by the LPRM strings are arranged in the horizontal direction.

FIG. 3 is a bird's-eye view showing the relation between the cell-output sets processed in the oscillation power range monitor system according to the first embodiment and the LPRM detectors. As specified above, each of the LPRM strings 2a, 2b, 2c and 2d has four LPRM detectors A, B, C and D. Each cell-output set is composed of four LPRM detectors output selected from the LPRM strings 2a, 2b, 2c and 2d, respectively. More precisely, the cell-output set is composed of the LPRM detector A of the LPRM string 2a, the LPRM detector D of the LPRM string 2b, the LPRM detector B of the LPRM string 2c and the LPRM detector C of the LPRM string 2d. The LPRM detector 1 of each LPRM string is never a constituent element of two or more cell-output sets.

The LPRM detectors 1 are provided to detect neutron flux at each of the positions where they are located. They detect not only the neutron fluxes, but also gamma ray fluxes, if any. In the output signal of any LPRM detector 1, the component resulting from a neutron flux and the component resulting from a gamma-ray flux can hardly be isolated from each other.

In the system which uses a substance such as U²³⁵ that reacts with neutrons to cause nuclear fission or B¹⁰ that reacts with neutrons to undergo nuclear transmutation, the substance reduces in amount during the period of measuring the neutron fluxes. This inevitably deteriorates the sensitivity for detecting neutron fluxes, but would not deteriorate the sensitivity for detecting gamma-ray fluxes. As a result, the sensitivity for detecting neutron fluxes will relatively deteriorate. In this embodiment, the LPRM detectors 1 have such operating characteristic as described above.

With reference to FIG. 1 again, the oscillation power range monitor system 50 will be further described. The oscillation power range monitor system 50 receives the signals from the LPRM detectors 1, and processes these signals, determining the output oscillation of the reactor core 102. If the oscillation power range monitor system 50 finds the core power oscillation abnormal, it generates a reactor trip signal.

The oscillation power range monitor system 50 has a plurality of OPRM units 10. Each OPRM unit 10 receives a plurality of cell-output sets. In order to process the cell-output sets, the oscillation power range monitor system 50 is configured as will be described below.

Each OPRM unit 10 has a noise filter 11, a bypass processing unit 12, a correction value multiplying unit 13, a cell average calculating unit 14, a time average calculating unit 15, a normalized cell value calculating unit 16, and a trip determining unit 17. Each OPRM unit 10 further has a correction value calculating unit 21 for calculating a correction value to be multiplied at the correction value multiplying unit 13.

To process a plurality of cell-output sets that have been input, each OPRM unit 10 may have as many processing components as the cell-output sets that have been input, thereby to process the cell-output sets in parallel. Alternatively, each OPRM unit 10 may have only one processing component, thereby to process the cell-output sets in series. Still alternatively, each OPRM unit 10 may have a plurality of processing components but fewer than the cell-output sets that are input. In FIG. 1, the configuration of only one of the OPRM units 10 is illustrated.

The noise filter 11 performs noise filtering on the neutron flux signals input to the OPRM unit 10.

When a failure or malfunction occurs in any one or more than one LPRM detectors 1, or in any one or more than one LPRM units (3a, 3b, 3c or 3d), the bypass processing unit 12 removes the appropriate neutron flux signal. If the LPRM detector signal has been bypassed in the LPRM detector 1 side, the bypass processing unit 12 bypasses the signal from that LPRM detector so that only the effective LPRM detection signals may undergo the ensuing processes. If any LPRM detection signal has a value of 5% or less of the value of other LPRM detection signals, the bypass processing unit 12 also bypasses that LPRM detection signal.

The correction value multiplying unit 13 is a signal and prescribed value adjusting unit that adjusts the relation between a normalized cell value and a prescribed value, thereby to compensate for the deterioration in the neutron flux sensitivity of any LPRM detector 1. More specifically, the correction value multiplying unit 13 multiplies the neutron flux signals by the correction values as compensation values output from the correction value calculating unit 21.

The correction value calculating unit 21 calculates correction value and outputs the correction value to the correction value multiplying unit 13. More precisely, the correction value calculating unit 21 receives the LPRM gain adjusting coefficients allocated to the LPRM detectors 1 respectively, and calculates each of the correction values from the LPRM gain adjusting coefficients. The LPRM gain adjusting coefficients are gains determined in LPRM side by which the outputs of the LPRM detectors 1 has been multiplied as the LPRM detectors 1 are calibrated on the LPRM side.

The cell average calculating unit 14 calculates an average cell value, by averaging signals of a plurality of channels as the cell output set signals. The time average calculating unit 15 calculates a time average cell value, i.e., averages temporally the value calculated by the cell average calculating unit 14 in a prescribed time period. The normalized cell value calculating unit 16 calculates a ratio of the average cell value to the time average cell value, and outputs this ratio, as a normalized cell value, to the trip determining unit 17.

The trip determining unit 17 receives, as input, the normalized cell value calculated by the normalized cell value calculating unit 16. The trip determining unit 17 then compares the normalized cell value with a prescribed value, and determines whether the normalized cell value has exceeded a prescribed condition or not. If the normalized cell value has exceeded a prescribed condition, the trip determining unit 17 outputs a reactor trip signal. The trip determining unit 17 has an amplitude base trip determining unit (ABA determining unit) 17a configured to compare the oscillation with a first prescribed specific value, a growth rate base trip determining unit (GBA determining unit) 17b configured to compare the growth rate of oscillation with a second prescribed value, a period base trip determining unit (PBDA determining unit) 17c configured to compare the oscillation in a prescribed period with the a prescribed oscillation condition, and an OR circuit 17d configured to output a reactor trip signal if any one of these units 17a, 17b and 17c determines that the oscillation has normalized cell value has exceeded a prescribed condition.

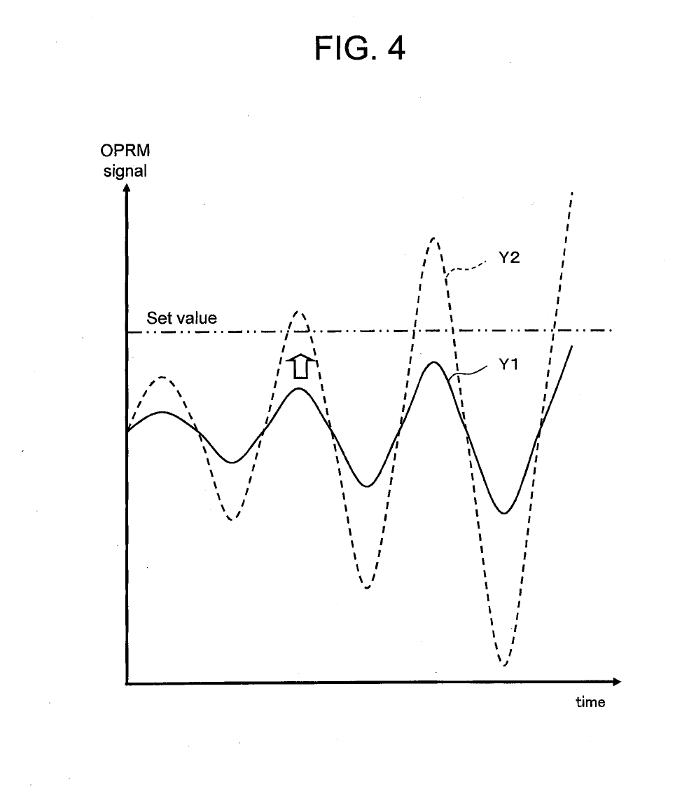

FIG. 4 is a diagram showing the relation between the change with time of the output signal and a preset value in the oscillation power range monitor system according to the first embodiment. In FIG. 4, the solid curve Y1 indicates the input to the correction value multiplying unit 13, and the broken curve Y2 indicates the output of the correction value multiplying unit 13, which has been generated by multiplying the output of the correction value calculating unit 21 by a constant value.

As viewed from another perspective, the broken curve Y2 indicates the temporal changes of the part of neutron flux in the input signal from the LPRM detector 1, supposing the sensitivity the LPRM detector 1 has not deteriorated. If the power oscillates at the position where the LPRM detector 1 is provided in the reactor core 102, the output of the LPRM detector 1 will change as illustrated by the broken curve shown in FIG. 4. FIG. 4 does not show that component of the input signal resulting from the gamma-ray flux.

Assume that the sensitivity of the LPRM detector 1 to the neutron flux has deteriorated. In this case, too, the output of the LPRM detector 1 has been generated by evaluating the core power based on the heat balance of the nuclear power plant 100 and calibrating the LPRM detectors 1 by means of a travelling in-core probe (TIP). However, the value calibrated is the sum of two components resulting from the neutron flux and gamma-ray flux, respectively. Hence, the gamma-ray flux contributes more in this case than in the case where the detector's sensitivity to neutron flux does not deteriorate at all. That is, within the components different in response time, the time-delayed component increases, whereas the fast responding component resulting from the neutron flux contributes less. If the power oscillates in this state, within the output of the LPRM detectors 1, the component resulting from the neutron flux, which changes as the output oscillates, is small, whereas the component resulting from the gamma-ray flux, which changes with a delay with respect to the output oscillation, is large. The solid curve Y1 shown in FIG. 4 indicates the temporal change of the component resulting from the neutron flux. Temporal change of the component resulting from the gamma-ray flux is not illustrated. In this case, the output of the LPRM detector needs more time to reach the prescribed value (set value) than in the case where the component of the input signal changes as indicated by the broken curve Y2.

Hence, it is important to detect a change of the component resulting from the neutron flux as soon as possible so that an abnormal power oscillation may be detected quickly. In order to compensate for the deterioration in the sensitivity to the neutron flux, it is therefore effective to multiply the neutron flux signal by a correction value in the correction value multiplying unit 13, thereby to change the value contributed by the neutron flux back to the corrective value contributed by the neutron flux.

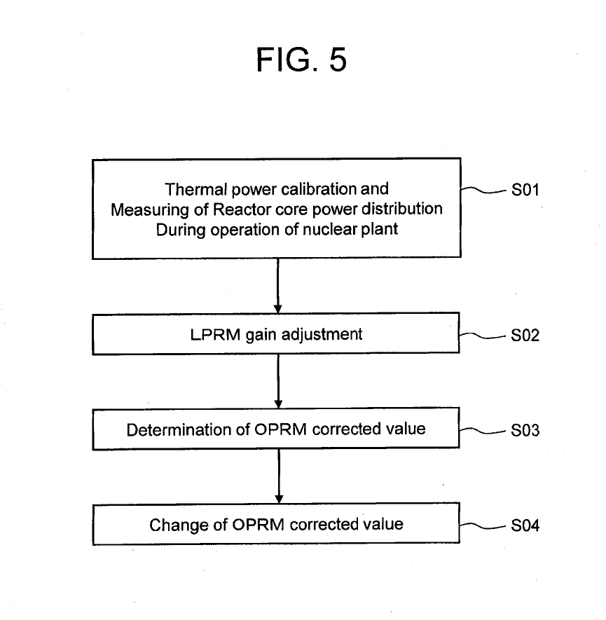

FIG. 5 is a flowchart showing a method of operating the nuclear power plant by using the oscillation power range monitor system according to the first embodiment.

While the nuclear power plant 100 is operating in normal state, each LPRM detector 1 is calibrated (Step S01). That is, the thermal power of the nuclear power plant 100 is calibrated, determining the macro neutron flux level in the reactor core 102. Further, the travelling in-core probe (TIP) measures the distribution of the core power.

Thus, the neutron flux level at each LPRM detector 1 is determined, and each LPRM detector is calibrated. More specifically, the gain of each LPRM detector is adjusted (Step S02).

An OPRM correction value is determined from the gain multiplied in the above-mentioned gain adjustment of the LPRM detector 1. Assume that gain multiplied in the LPRM detector is G, and the initial output m1 of the LPRM detector 1 has components n1 and γ1 resulting from a neutron flux and a gamma-ray flux, respectively. Also assume that the output m2 of the LPRM detector 1 having neutron flux sensitivity deteriorated has components n2 and γ2 resulting from a neutron flux and a gamma-ray flux, respectively. Further assume that the sensitivity to the gamma-ray flux of the LPRM detector 1 has not deteriorated at all. Therefore, γ1=γ2=γ.

The initial state of m1=n1+γ=1 may be regarded as reference. Hence, m2=n2+γ<(m1=1) 1 because n2<n1. Assume that the LPRM detector 1 has been calibrated, maintaining its initial output value. Then, the gain G on the LPRM side will be m1/m2 (G=m1/m2) if it is the value that will be multiplied by the output generated after its sensitivity has deteriorated. The gain G is given by the following equation (1):

G=m1/m2=1/(n2+γ)=1/(n 2+1−n1) (1)

The component of the output of the LPRM detector 1, which has resulted from the gamma-ray flux, i.e., γ=(1−n1), may be sufficiently small, namely n1=1. In this case, the gain G is given by the following equation (2), compensating for the deterioration in only the component resulting from the neutron flux.

G=m1/m2=n1/n2=1/n2 (2)

Based on the equation (1) or the equation (2), the OPRM correction value is determined (Step S03). If the equation (2) is approximately established, the constant for multiplying the gain to maintain, on the OPRM side, the component resulting from the neutron flux will be obtained similarly. The OPRM correction value may therefore be proportional to the gain G of the LPRM detector 1.

The correction value calculating unit 21 receives the gain G of the LPRM detector 1 and calculates the correction value that should be set on the OPRM side (Step S04). The correction value so calculated is output to the correction value multiplying unit 13, whereby the correction is performed.

In this embodiment described above, a correction process is performed, compensating for the deterioration in the component resulting from the neutron flux, which is the main cause of the deterioration of the sensitivity of the LPRM detector 1. Therefore, the delay of detecting the output oscillation can be reduced.

### Second Embodiment

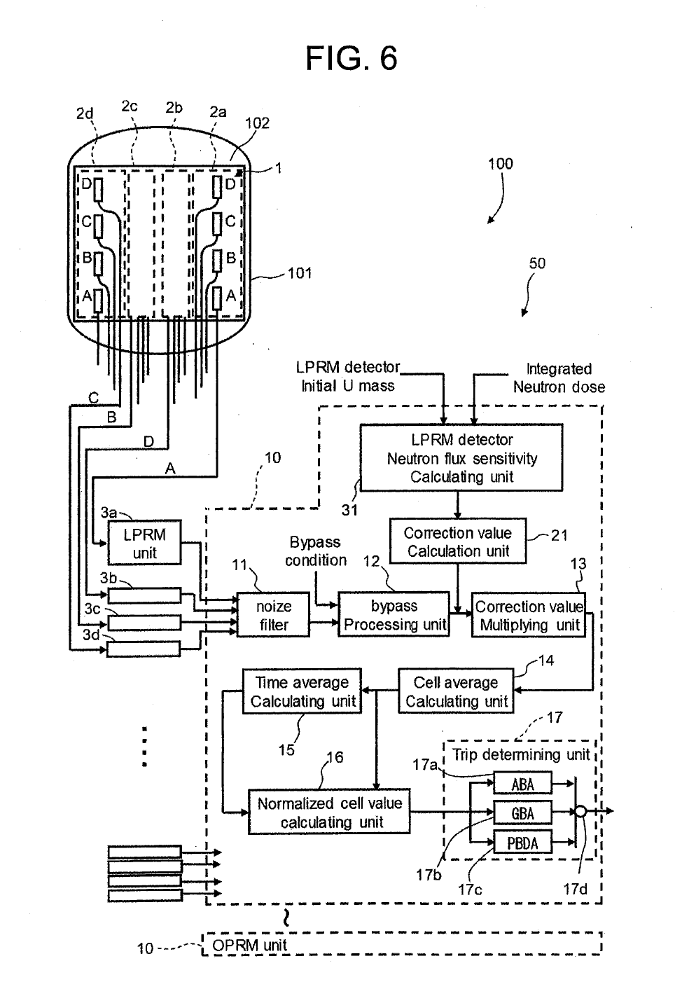

FIG. 6 is a block diagram showing the configuration of an oscillation power range monitor according to the second embodiment. The second embodiment is a modification of the first embodiment. In the second embodiment, each of the OPRM units 10 incorporated in the oscillation power range monitor system 50 has a neutron flux sensitivity calculating unit 31.

The neutron flux sensitivity calculating unit 31 calculates the sensitivity of each LPRM detector 1 to the neutron flux, on the basis of the amount of the fissionable substance such as U²³⁵ loaded in the LPRM detector 1 at the time of manufacturing the LPRM detector 1 and also on the basis of the cumulative amount of neutrons applied to the LPRM detector 1. The neutron-flux sensitivity so calculated is output to the correction value calculating unit 21.

The cumulative amount of neutrons applied to the LPRM detector 1 can be calculated on the basis of the operation record of the nuclear power plant 100, such as the calculated power distribution in the reactor core 102 and output history of the appropriate LPRM detector 1. Thus, the ratio of n1 to n2 in the equation (2) can be directly calculated.

In the second embodiment described above, the decrease in the component mainly resulting from deteriorating of the neutron flux sensitivity of the LPRM detector 1, is directly evaluated. And, correction can be made to reduce the delay of detecting the core power oscillation.

### Third Embodiment

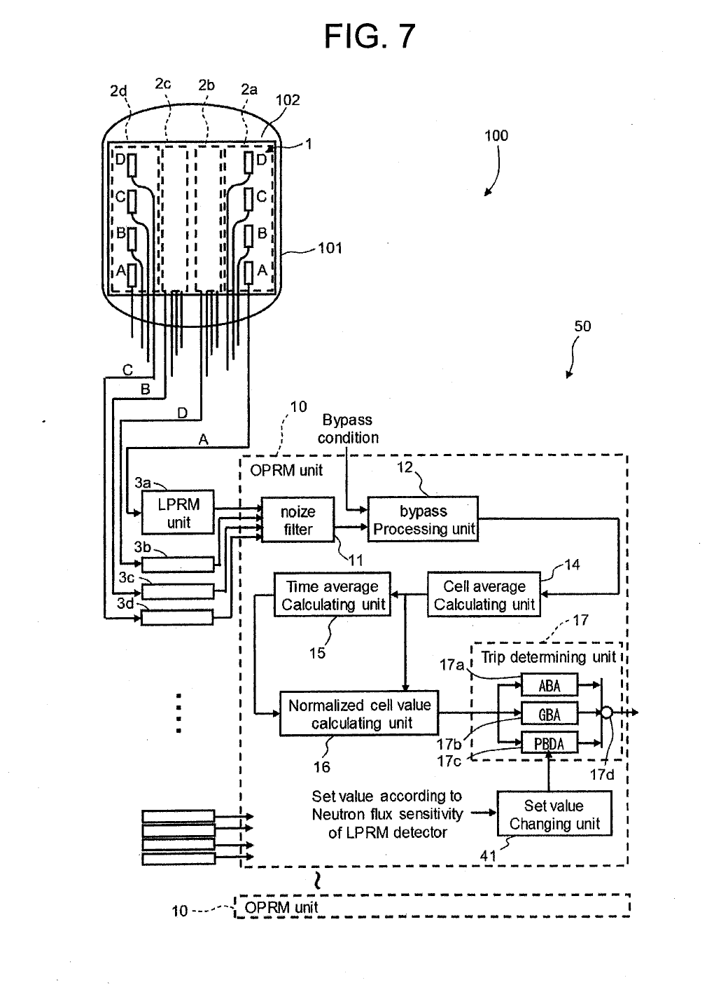

FIG. 7 is a block diagram showing the configuration of an oscillation power range monitor according to the third embodiment. The second embodiment is another modification of the first embodiment. The first embodiment has a correction value multiplying unit 13 and a correction value calculating unit 21, which are used as a signal and prescribed value adjusting unit that adjusts the relation between a normalized cell value and a prescribed value, thereby to compensate for the deterioration in the neutron flux sensitivity of the LPRM detectors 1. By contrast, the third embodiment has neither a correction value multiplying unit 13 nor a correction value calculating unit 21.

The third embodiment has a set value changing unit 41, which is used as signal and prescribed value adjusting unit. That is, the set value changing unit 41 adjusts the relation between a normalized cell value and a prescribed value, thereby to compensate for the deterioration in the neutron flux sensitivity of the LPRM detectors 1.

The set value changing unit 41 receives a prescribed value that accords with the neutron flux sensitivity of the LPRM detectors 1. In accordance with the prescribed value, the set value changing unit 41 changes the three set values used in the ABA determining unit 17a, the GBA determining unit 17b and the PBDA determining unit 17c of the trip determining unit 17.

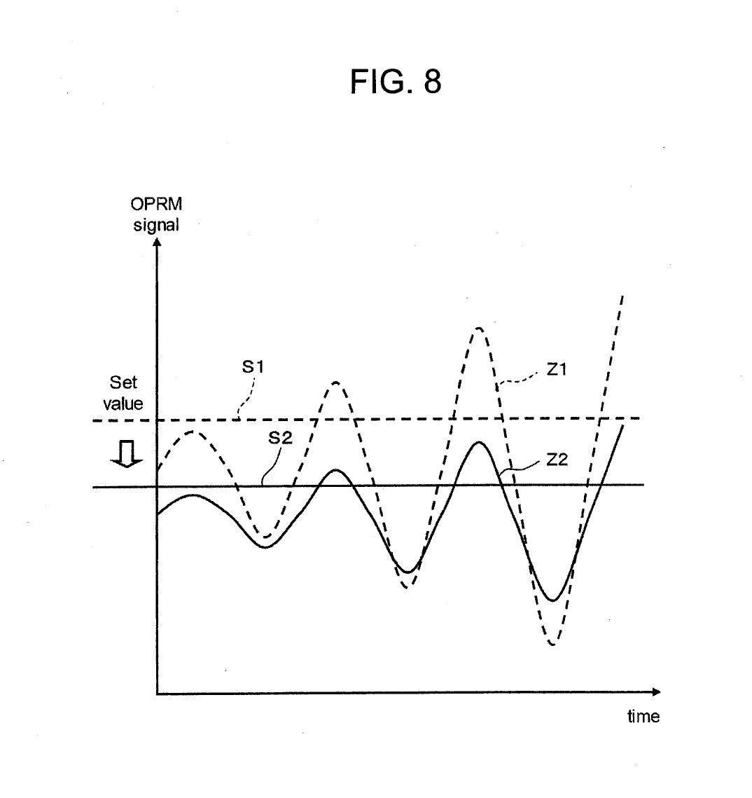

FIG. 8 is a diagram showing the relation between the change with time of the output signal and a preset value in the oscillation power range monitor system according to the third embodiment. In FIG. 8, the broken curve Z1 indicates the signal component resulting from the initial neutron flux, and the solid curve Z2 indicates the signal component resulting from the neutron flux detected after the sensitivity has deteriorated. Also in FIG. 8, the broken line S1 indicates the initial set value, and the solid line S2 indicates the value set after the sensitivity has deteriorated.

Since the component resulting from the initial neutron flux, indicated by the curve Z1, decreases as indicated by the curve Z2 after the sensitivity has deteriorated, the prescribed value S1 is decreased to the prescribed value S2. As a result, the output Z2 the LPRM detector 1 generates after its sensitivity has deteriorated reaches the value of the preset value S2, not delayed from the time the initial output Z1 of the LPRM detector 1 reaches the preset value S1. Hence, the third embodiment can achieve the same advantage as the first embodiment.

### Other Embodiments

Several embodiments of the present invention have been described above. However, those embodiments are described above only as exemplar embodiments without any intention of limiting the scope of the present invention.

Furthermore, each of the above-described embodiments may be put to use in various different ways and, if appropriate, any of the components thereof may be omitted, replaced or altered in various different ways without departing from the spirit and scope of the invention.

Therefore, all the above-described embodiments and the modifications made to them are within the spirit and scope of the present invention, which is specifically defined by the appended claims, as well as their equivalents.

What is claimed is:

1. An oscillation power range monitor system designed to monitor oscillation of power of a nuclear reactor and output a reactor trip signal to shut down the nuclear reactor automatically if the oscillation is found abnormal, the system comprising:
a plurality of OPRM units, each of the OPRM units receiving and processing cell-output set signals coming from any selected LPRM detectors of LPRM strings arranged at the four corners of a cell of a lattice, the LPRM strings being arranged in a reactor core in the form of the lattice on the horizontal plane of the reactor core, each LPRM strings having a plurality of LPRM detectors configured to detect a neutron flux and a gamma-ray flux and having neutron flux sensitivity more decreasing than gamma-ray flux sensitivity over a period for measuring the neutron flux, wherein each of the OPRM units has:
a cell average calculating unit receiving cell-output set signals and averaging the cell-output set signals, thereby calculating a cell average value;
a time average calculating unit calculating a time average cell value that is temporal average of the value calculated by the cell average calculating unit in a prescribed time period;
a normalized cell value calculating unit calculating a normalized cell value that is a ratio of the average cell value to the time average cell value;
a trip determining unit outputting a reactor trip signal if amplitude or growth rate of oscillation of the normalized cell value has exceeded a prescribed value, or period of oscillation of the normalized cell value has exceeded a prescribed condition; and
a signal and prescribed value adjusting unit adjusting relation between the normalized cell value and the specific value, thereby compensating for deterioration in the neutron flux sensitivity of any LPRM detector in order to keep outputting the reactor trip signal.

2. The oscillation power range monitor system according to claim 1, wherein the signal and prescribed value adjusting unit has:
a correction value multiplying unit receiving the cell-output set signals and multiplying the cell-output set signals by a correction value, thereby compensating for the deterioration in the sensitivity to the neutron flux, ultimately increasing the value of the cell-output set signals; and
a correction value calculating unit calculating the correction value from the deterioration in the sensitivity of the LPRM detector to the neutron flux and outputting the correction value to the correction value multiplying unit.

3. The oscillation power range monitor system according to claim 2, wherein the correction value is determined from the gain by which the output of LPRM detector has been multiplied by calibrating the LPRM detector.

4. The oscillation power range monitor system according to claim 1, wherein the signal and prescribed value adjusting unit has a set value changing unit, a set value changing unit multiplying a correction value, thereby compensating for a deterioration in the sensitivity to the neutron flux, then decreasing the specific value for use in the trip determining unit and finally outputting the specific value to the trip determining unit.

5. A method of operating a nuclear power plant comprising an oscillation power range monitor system designed to monitor oscillation of power of a nuclear reactor and output a reactor trip signal to stop the nuclear reactor automatically if the oscillation is found abnormal, the system comprising OPRM units, each of the OPRM units receiving and processing cell-output set signals coming from any selected LPRM detectors of LPRM strings arranged at the four corners of a cell of a lattice, the LPRM strings being arranged in a reactor core in the form of the lattice on the horizontal plane of the reactor core, each LPRM strings having a plurality of LPRM detectors configured to detect a neutron flux and a gamma-ray flux and having neutron flux sensitivity more decreasing than gamma-ray flux sensitivity over a period for measuring the neutron flux, the method comprising:
an in-plant measuring step of performing thermal power calibration and core power distribution measuring while the nuclear power plant is operating;
an LPRM gain adjusting step of adjusting the gain of the LPRM signal in accordance with the result of the in-plant measuring step;
an OPRM correction value determining step of determining, from the result of the LPRM-gain adjusting step, a correction value for the signal and prescribed value adjusting unit of the oscillation power range monitor system; and
an OPRM correction value changing step of changing the correction value to the value determined in the OPRM correction value determining step.
